(19) United States
(12) Patent Application Publication
(10) Pub. No.: US 2014/0101012 A1
(43) Pub. Date: Apr. 10, 2014

(54) ONLINE CATALOGS AND COLLABORATIVE FINANCIAL PLANNING

(71) Applicant: Vsevolod Kuznetsov, (US)

(72) Inventor: Vsevolod Kuznetsov, Sankt-Petersburg (RU)

(73) Assignee: RAWLLIN INTERNATIONAL INC., Tortola (VG)

(21) Appl. No.: 13/647,732

(22) Filed: Oct. 9, 2012

(51) Int. Cl. G06Q 40/00

(52) U.S. Cl. 705/35

(57) ABSTRACT

Disclosed are electronic systems and techniques for implementing collaborative financial planning system for online shopping. An input component can receive a set of data related to a collaborative financial goal from one or more participating users (e.g., via user identities) and/or a set of data sources. A goal-setting component can generate a collaborative financial goal associated with an object from an online catalog based on least in part on the received set of data. The collaborative financial goal can include a description of the object, a set of participating users, and/or a target completion date. A planning component can dynamically generate a collaborative for participating users to achieve the financial goal and an execution component can execute the collaborative plan for the financial goal.

### TECHNICAL FIELD

The subject disclosure relates generally to electronic commerce, and more particularly to facilitating consumers of financial services in collaboratively achieving financial goals related to selections from online catalogs.

### BACKGROUND

Shopping online can be convenient and efficient. By avoiding physically travelling to stores, consumers can reduce costs and shop in increased comfort from home. Other pitfalls that consumers face shopping in the traditional manner are equally applicable to online shopping however. These include the temptation of purchasing items that the consumer cannot afford and inadvertently overextending credit on expensive items.

Collaboratively purchasing items online can alleviate some of these issues, but lack of communications and organization between the participating consumers can make it difficult to plan and achieve their goals. Integrating different personalities, desires, and financial knowledge into a single cohesive plan, and ensuring that each of the parties understand and complete their respective duties with regard to the plan can be difficult. Also, practical considerations such as how or where to maintain funds of respective parties can present additional difficulties.

Determining the best way to achieve their goals can be a difficult decision for the group as well. The decision about whether to purchase the item on credit, or by paying cash for the item can in some cases be influenced by the financial situations of the participating users. In other cases, the online shopping catalog may have fluctuating prices, or other catalogs may have different prices. Without this information, the consumers may not make the best decisions about purchases.

The above-described description is merely intended to provide a contextual overview of diagnostic and performance data collection, and is not intended to be exhaustive.

### SUMMARY

Various non-limiting embodiments provide for incorporating collaborative financial planning and online shopping. In an example embodiment, a system comprises a memory storing computer-executable components and a processor communicatively coupled to the memory that executes or facilitates execution of one or more of the computer executable components. The executable components can include a goal-setting component configured to generate a financial goal associated with an object from an online catalog. A planning component can be included to generate a collaborative plan for participating users (e.g., vis-à-vis user identities recognized by the system) to achieve the financial goal. Also included is an execution component configured to execute the collaborative plan for the financial goal.

In another example embodiment, a method comprises receiving, by a system including at least one processor, a selection of an object in an online catalog by a set of participating user identities and gathering financial information relating to the set of participating user identities. The method also includes creating a collaborative plan to achieve a goal associated with the object from the online catalog and executing at least one process toward carrying out the collaborative plan.

In another example embodiment, a tangible computer readable storage device has computer-executable instructions that, in response to execution, cause a system including a processor to perform operations comprising receiving a selection of an object in an online catalog from a set of participating user identities and gathering information about a set of financial statuses of the set of participating user identities. The operations further include creating a collaborative plan to achieve a goal associated with the object from the online catalog, where the collaborative plan is based at least in part on the set of financial statuses.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram illustrating an example, non-limiting embodiment of a collaborative financial planning system in accordance with various aspects described herein;

FIG. 2 is a block diagram illustrating an example, non-limiting embodiment of a collaborative financial planning system in accordance with various aspects described herein;

FIG. 3 is a block diagram illustrating an example, non-limiting embodiment of a monitoring and updating system in accordance with various aspects described herein;

FIG. 4 is a block diagram illustrating an example, non-limiting embodiment of a monitoring and updating system in accordance with various aspects described herein;

FIG. 5 is a block diagram illustrating an example, non-limiting embodiment of a goal-setting system in accordance with various aspects described herein;

FIG. 6 is a block diagram illustrating an example, non-limiting embodiment of a comparison system in accordance with various aspects described herein;

FIG. 7 is a block diagram illustrating an example, non-limiting embodiment of a rewards and incentive system in accordance with various aspects described herein;

FIG. 8 illustrates a flow diagram of an example, non-limiting embodiment of a method for collaborative financial planning;

FIG. 9 illustrates a block diagram of an example electronic computing environment that can be implemented in conjunction with one or more aspects described herein; and

FIG. 10 illustrates a block diagram of an example data communication network that can be operable in conjunction with various aspects described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the disclosure, as generally described herein, and illustrated in the Figures, can be arranged, substituted, combined, separated, and designed in a wide variety of different configurations, all of which are explicitly contemplated herein.

In various non-limiting embodiments, a collaborative financial planning system is provided to facilitate groups of consumers selecting and purchasing items from online catalogs (e.g. shopping portals, e-commerce sites, etc.). Users can select goods or services from incorporated online catalogs to set savings and/or investment goals. Alternatively, users can pay towards goods or services in the online catalogs (e.g. similar to layaway), directly from associated bank accounts. The financial planning tool can dynamically update or suggest changes to a goal based on changes to the catalogs (price changes, availability).

In an embodiment, the collaborative financial planning system determines the best payment plan based on information related to the financial status of the participating users. The collaborative financial planning system can also infer the preferred plan based on past usage and/or other information about the participating users. In some embodiments, the collaborative financial planning system can arrange for incentives or rewards to the participating users in response to achieving financial plan milestones or completing the financial plan.

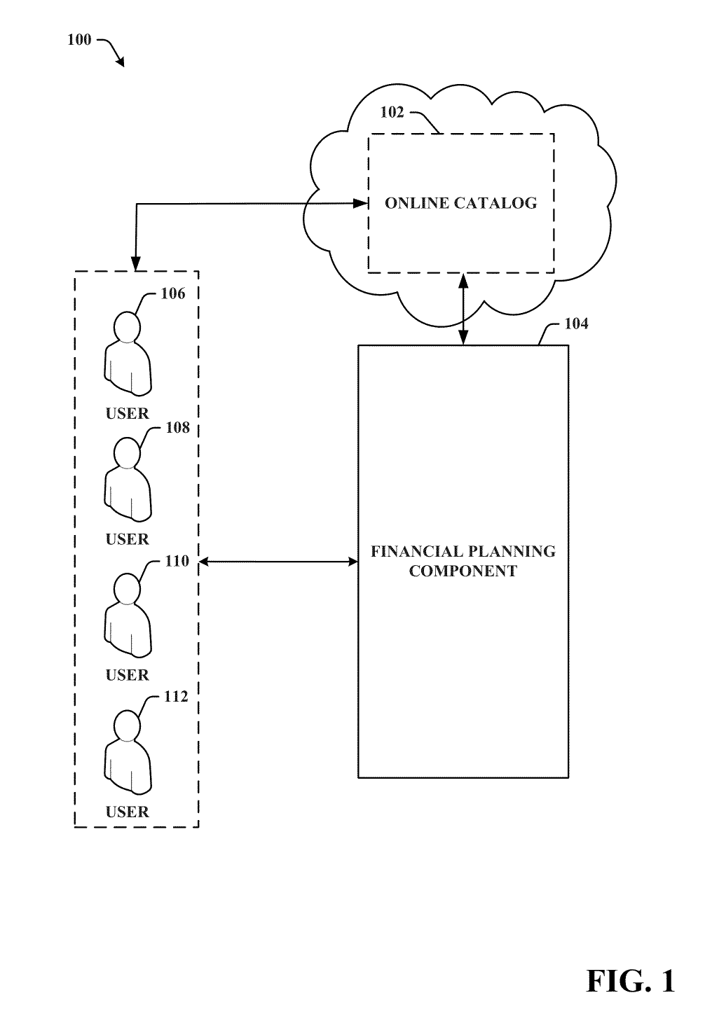

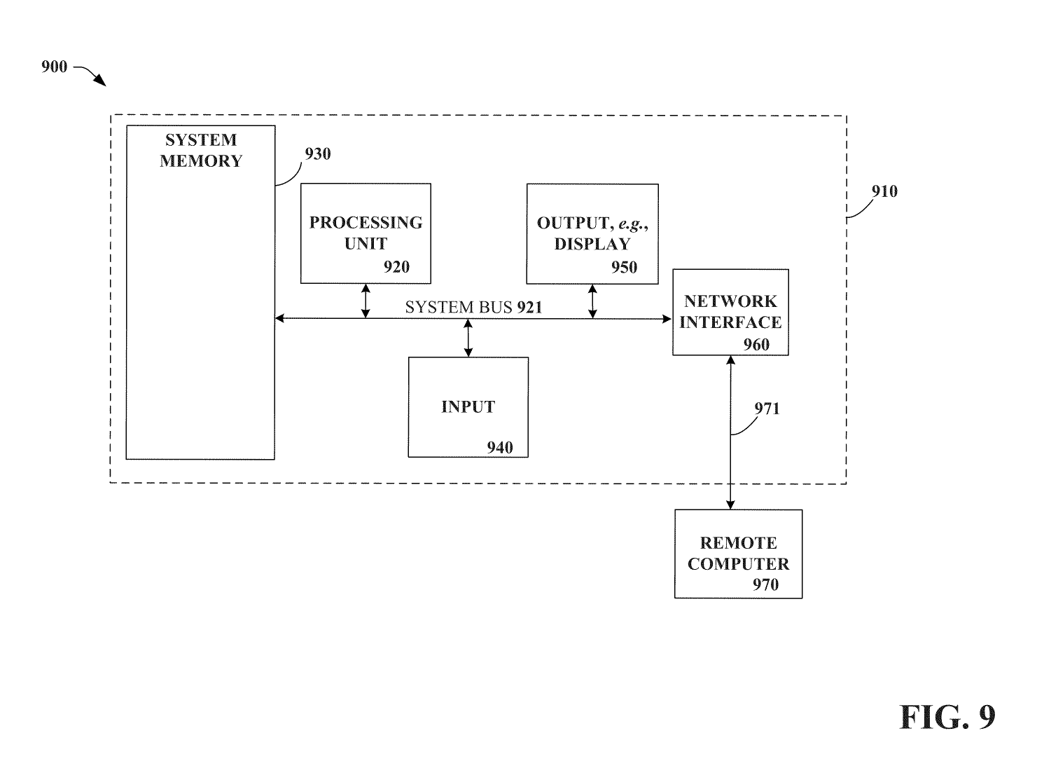

Referring now to FIG. 1, a block diagram illustrating an example, non-limiting embodiment of collaborative financial planning system 100 is shown. Generally, system 100 can include a memory that stores computer-executable component and a processor that executes the computer-executable components stored in memory, examples of which can be found with reference to FIG. 9. System 100 includes a financial planning component 104. The financial planning component 104 allows a set of participating users 106, 108, 110, and 112 to determine, set, or otherwise generate a collaborative financial plan with regard to an object, item, or service associated with an online catalog 102.

Participating users 106, 108, 110, and 112 can browse online catalog 102 and pick an item in the online catalog 102. The financial component 104 can help to determine a financial goal associated with the item, and then can generate a collaborative plan to achieve the goal. For example, if users 106, 108, 110, and 112 select an item from online catalog 102, financial planning component 104 can generate a money savings goal (e.g. dollar amount) to achieve by a specified date in order to purchase or rent the item.

In addition, the financial planning component 104 can develop, determine, or otherwise generate a plan to achieve the goal, and implement, carry out, or otherwise execute the plan. The plan can include but is not limited to individual financial plans (e.g., budget, etc.) for the respective users, contributions of respective users, and/or dates of contributions (contribution dates) of respective users. For instance, the financial planning component 104 can determine a first user 106 will contribute X dollars on a set of dates corresponding to a pay cycle of the first user 106, where X is a real number greater than zero. It is to be appreciated that while FIG. 1 shows four users, 106, 108, 110, and 112, the invention is not limited by a quantity of participating users. For example, the set of participating users can include Y users, where Y is an integer greater than zero.

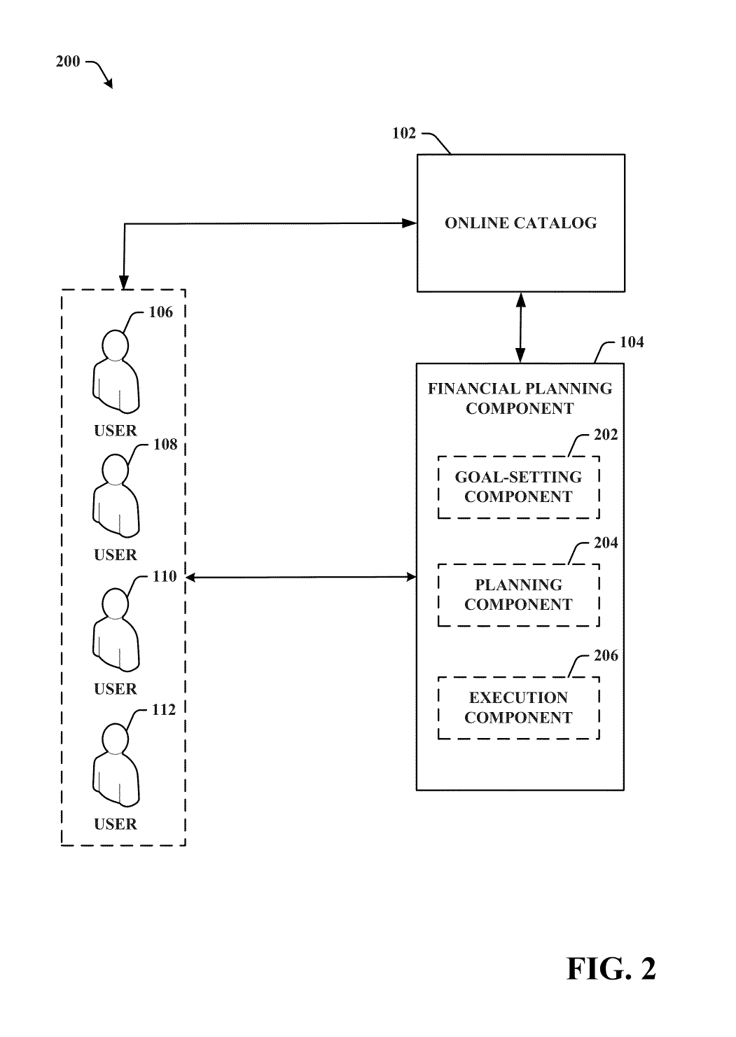

Turning now to FIG. 2, illustrated is a block diagram of a collaborative financial planning system 200 in accordance with various aspects described in this disclosure. System 200 includes a financial planning component 104, that as discussed previously, provides for a set of participating users 106, 108, 110, and 112 to determine, set, or otherwise generate a collaborative financial goal with regard to an item from an online catalog 102, generate a collaborative plan to achieve the goal, and execute the plan. The financial planning component 102 in FIG. 2 includes a goal-setting component 202, a planning component 204, and an execution component 206.

The goal-setting component 202 generates a financial goal associated with an object or item from the online catalog 102. The goal-setting component 202 can receive data (e.g., a selection of an object) from at least one user from the set of participating users 106, 108, 110, and 112 and determine the financial goal based at least in part on the received data. The financial goal data can include, but is not limited to, data regarding the set of participating users (e.g., identities of users, numbers of users, etc), the goal target (e.g., the object and the online catalog it is located in) and/or a target completion date.

In some embodiments, the goal-setting component 202 can infer a financial goal based on a user's or a set of participating users preferences or past actions. For example, if a set of users purchase a cruise vacation ever year on a particular holiday from an online portal, goal-setting component 202 can infer that for the upcoming year, the users will again book a cruise vacation on that holiday, and so set the cruise package as a financial goal for which to prepare. In some embodiments, the goal-setting component 202 can also indirectly infer a goal. For instance, if a set of users purchase the cruise vacation for a holiday, the goal-setting component 202 can generate a collaborative financial goal of purchasing tickets for a flight to the cruise embarkation location from the participating users home locations.

Depending on the online catalog 102, the goal-setting component 202 can also determine what type of financial goal should be generated. For instance, the goal-setting component 202 can determine whether the financial goal is to purchase the object or service, or rent an item. It is also to be appreciated that this disclosure is not limited to shopping portals but can cover all occasions of e-commerce. Online catalogs can include lists of charities to which to donate, real-estate property in which to invest, and/or bank accounts in which to save money. An example of a collaborative financial goal can thus be to raise an amount of money from a set of users to give to a charity for a benefit drive. Another example of a collaborative financial goal could be for a set of participating users to save and transfer an amount of money into a particular bank account.

Planning component 204 can generate a collaborative plan for the participating users to achieve the financial goal based on the goal data (e.g., received using the goal-setting component 202). In some embodiments, planning component 204 can generate a set of collaborative plans and present the plans to the participating users 106-112 who can then choose the collaborative plan they would like to pursue. Alternatively, a subset of the participating users can adjust or modify a potential plan generated by the planning component 204, and select the modified plan.

The planning component 204 can receive information from the participating users 106, 108, 110, and 112 and use the received information to help create the collaborative plan. The collaborative plan can include contribution amounts, contribution times, and so on to achieve the financial goal. For instance, if the item from the online catalog 102 costs $10,000, planning component 204 can create a collaborative plan where each of users 106-112 contribute $2,500, with $500 collected from each user every month for five months. Planning component 204 can also take information regarding the financial status of each of the users into account. For example, if a user has a more secure financial status (e.g., more money, better credit, etc.), or has indicated a willingness to contribute increased amounts, planning component 204 can take this information into account, and the collaborative plan can have that user(s) contribute an increased amount.

Execution component 206 implements, carries out, or otherwise executes a selected plan. For example, the execution component 206 can execute deposits, withdrawals, transfers, and/or payments (e.g., for accounts payable, etc.) based on the selected plan. For instance, based on the selected plan, the execution component 206 can facilitate automatic funds transfers, and/or provide reminders to participating users 104. Additionally, the execution component 206 analyses, tracks, or otherwise monitors progress with regard to the goal, and adjusts or updates the selected plan based on the progress.

In some embodiments, execution component 206 can collect money throughout the period of the collaborative plan and transfer the funds when the total amount of money or funds have been raised. In other embodiments, execution component 206 can transfer the funds periodically as they are raised.

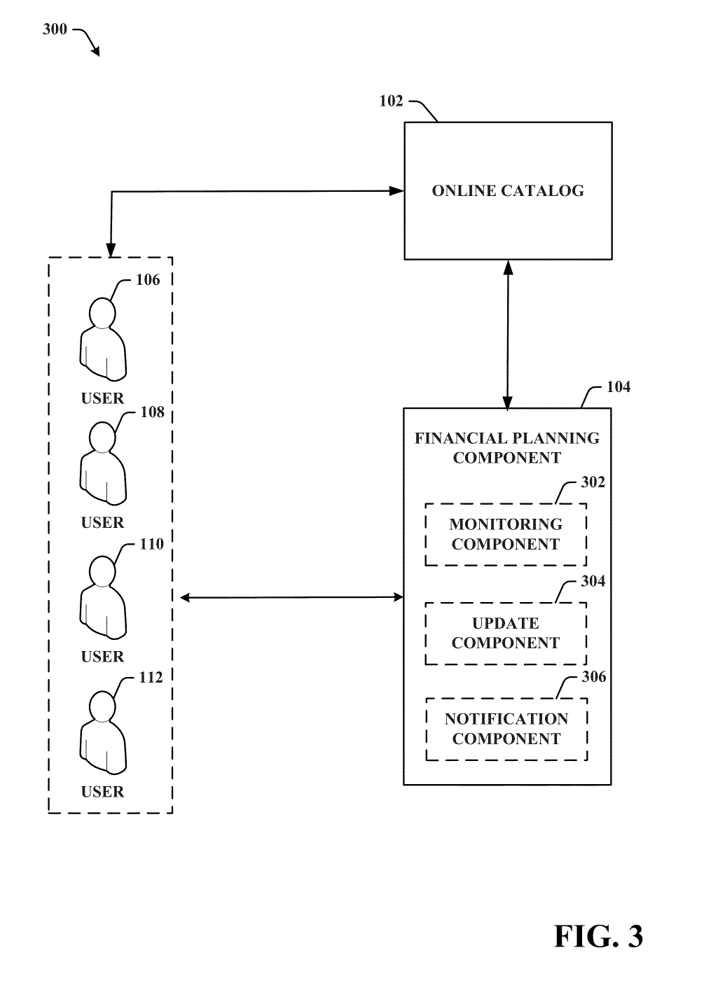

FIG. 3 is a block diagram illustrating an example, non-limiting embodiment of a monitoring and updating system 300 in accordance with various aspects described herein. Included in system 300 is the financial planning component 104 with a monitoring component 302, an update component 304 and a notification component 306.

Monitoring component 302 can be configured to check for changes in the online catalog 102. Online catalog 102 can have prices for items fluctuate. The availability of some items may also change. Monitoring component 302 can track these changes and keep a record of the changes. In some embodiments, monitoring component 302 can check for changes periodically at predefined intervals. In other embodiments, monitoring component 302 can passively monitor the online catalog 102 by receiving notices directly from the online catalog 102 whenever changes have been made.

In some embodiments, in response to change being detected by monitoring component 302, notification component 306 can send an alert to one or more of the participating users 106, 108, 110, and 112 notifying them of the change. Notification component 306 can send alerts for all changes, or alternatively can send alerts only for certain types of changes in the online catalog 102. For example, notification component 306 may send alerts only if the item is no longer available and not whenever the price changes. Alternatively, notification component 306 may send an alert when the price increases, but not when the price decreases. In some embodiments, the participating users 106-112 may indicate which classes of changes they want to hear alerts about, and in other embodiments, notification component 306 can determine which alerts the participating users 106-112 desire to hear about based on past activity, type of change, financial status of the participating users, and so on.

Update component 304 can be configured to automatically update the collaborative plan in response to a change to the object from the online catalog 102. The update component 304 can make a change such that the target completion date is met. For instance, if the price of an object increases by 10%, the update component 304 can change the contribution amounts by 10% in order to keep the same target completion date. In other embodiments, depending on the financial status of the participating users, update component 304 can maintain the same periodic contribution amounts for the participating users, but increase the number of contributions that have to be made. If the item is no longer available from the online catalog 102, the update component 304 can select the same item from a different online catalog, or select a similar item from the same online catalog 102.

In other embodiments, the update component 304 will only update the collaborative plan once a response has been received from the participating users 106-112 after the alert was sent by notification component 306. In some embodiments, the update component 304 can propose a modification to the collaborative plan and notification component 306 can send the proposal to the participating users 106-112 and implement the proposal based on the response received.

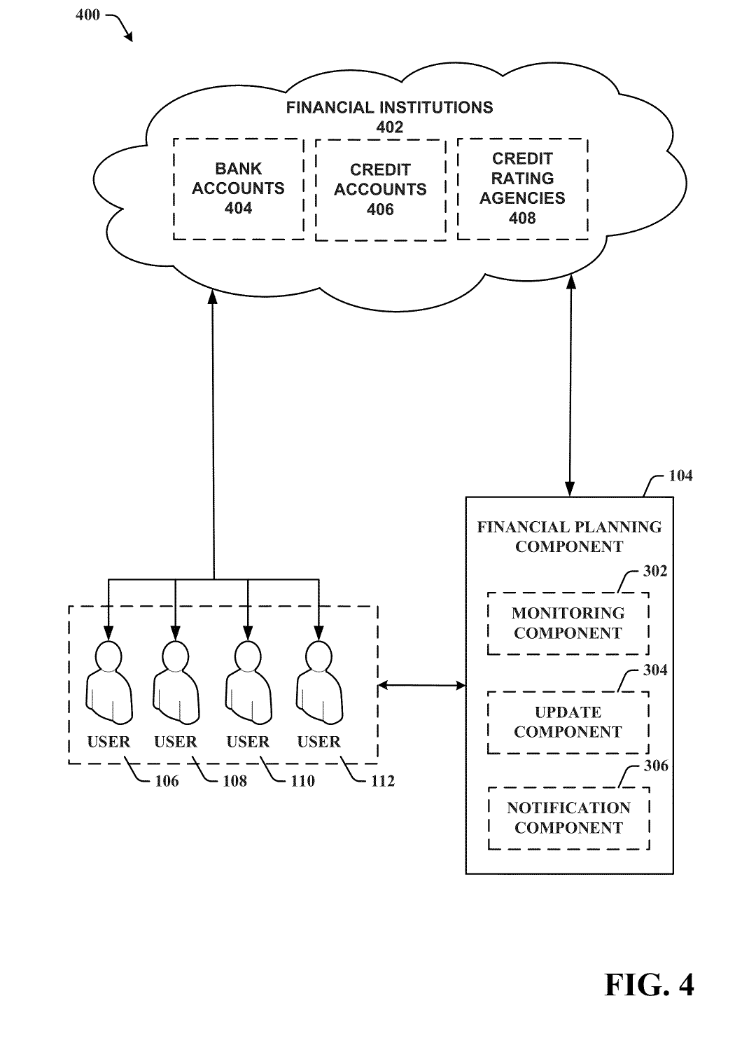

Turning now to FIG. 4, a block diagram illustrating an example, non-limiting embodiment of a monitoring and updating system 400 in accordance with various aspects described herein is shown. Included in system 400 is the financial planning component 104 with a monitoring component 302, an update component 304 and a notification component 306. The monitoring component 302 is configured to monitor a financial status of the participating users 106, 108, 110, and 112. To do so, monitoring component 302 monitors financial institutions 402 that are associated with the participating users. Included in financial institutions 402 are bank accounts 404, credit accounts 406, and credit rating agencies 408.

Monitoring component 302 can monitor balance levels of bank and credit accounts 404 and 406. Monitoring component 302 can also monitor credit scores as reported by credit rating agencies 408. Monitoring component 302 can determine whether or not any of the participating users 106-112 have taken out loans, defaulted on payments or are otherwise suffered a loss of financial security. In some embodiments, when changes are detected by monitoring component 302, update component 304 can update the collaborative plan. For example, if one or more of the participating users 106, 108, 110, and 112 have gone bankrupt, or otherwise lost financial security, update component 304 can modify the collaborative plan such that the other participating users shoulder an increased burden of the load. In other embodiments the update component 304 may increase the burden of one of the participating users if that user has received a financial windfall.

In some embodiments, notification component 306 can send a notification and/or an alert to the participating users notifying them of the change in financial status. Update component 304 can then update the collaborative plan based on the response that is received back from the participating users. For instance, the participating users may opt to cancel the collaborative plan and no longer pursue the financial goal in response to receiving news of the financial status change. In such a case, update component 304 will discontinue the collaborative plan.

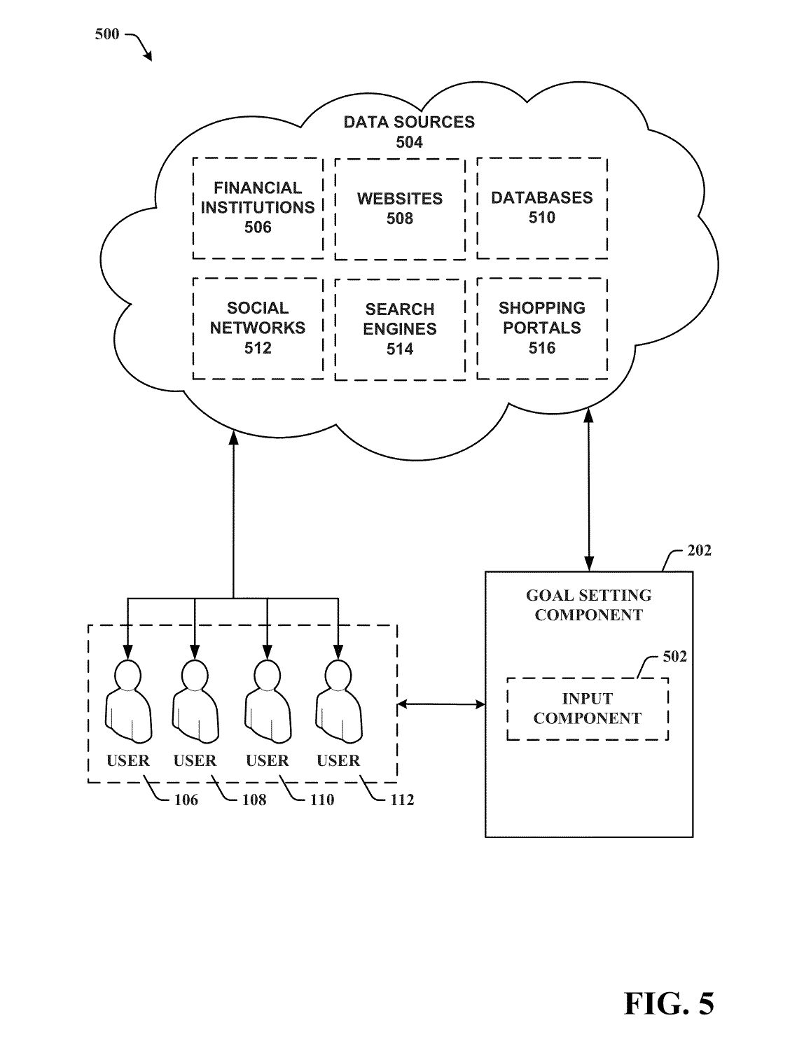

Referring now to FIG. 5, a block diagram illustrating an example, non-limiting embodiment of a goal-setting system 500 is shown. Goal-setting component 202 can include input component 502. Input component 502 can retrieve information associated with a financial goal from at least one of the participating users 106, 108, 110, and 112. The data related to the financial goal can be retrieved from data sources 504 that can include financial institutions 506, websites 508, databases 510, social networks 512, search engines 514 and shopping portals 516.

The input component 502 obtains, acquires, or otherwise receives inputs or data related to a set of goal data from one or more of the participating users 106-112, an online catalog (e.g., online catalog 102), a financial institution 506 (e.g., bank, investment account, etc.) a website 508, a database 510, a social network 512, a search engine (e.g., a search engine result set) 514 and a shopping portal 516. For example, in one embodiment, the input component 502 generates, manages, or otherwise controls a user interface, and/or application programming interface (API) to facilitate receiving the input. The input can include but is not limited to explicit user inputs (e.g., configuration selections, question/answer) such as from mouse selections, keyboard selections, speech, and so forth. For instance, the user 106 can provide a first subset of the goal data via selections included in a user interface (e.g., generated using the input component 502). As an additional or alternative example, in one embodiment, the input can include data uploads, wherein a data upload is a transfer of data from the user or a third party source (e.g. computer or a computer readable medium), to the input component 502. For instance, an online catalog (e.g., online catalog 102) and/or a bank (e.g., financial institution 506) not associated with the financial planning component 104 can provide data related to the goal data to the input component 502 (e.g., via an API).

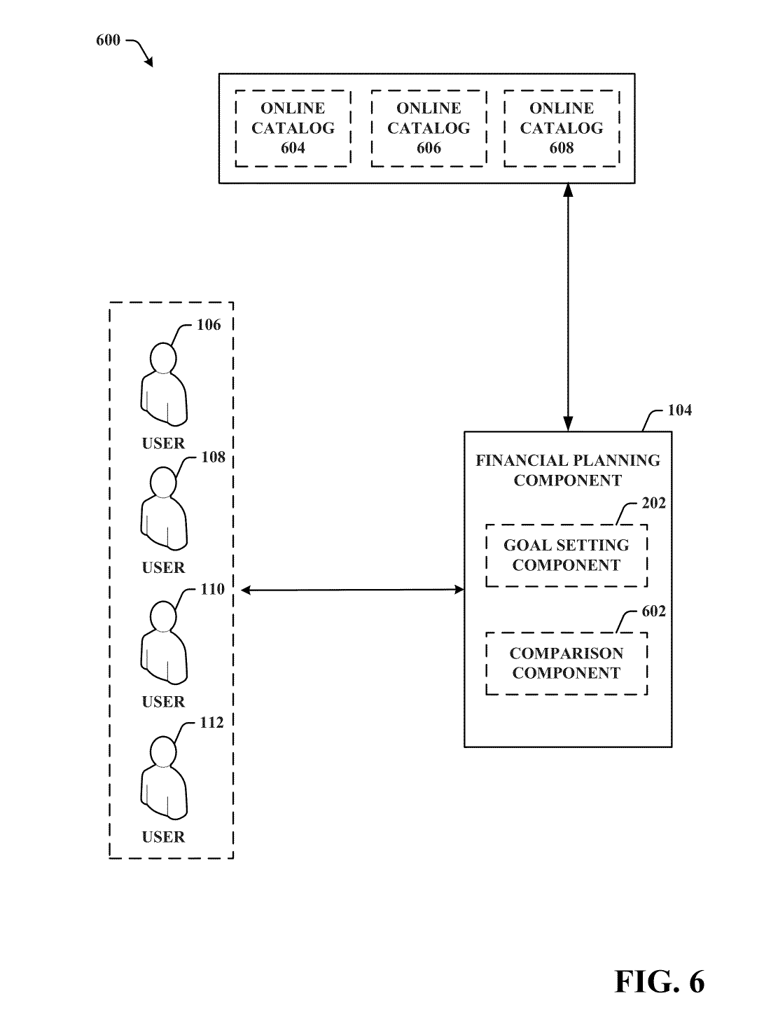

FIG. 6 illustrates a block diagram of an example, non-limiting embodiment of a comparison system 600 in accordance with various aspects described herein. System 600 includes a financial planning component 104 with a goal-setting component 202 and a comparison component 602 that compares items and/or classes of items in online catalogs 604, 606, and 608.

Comparison component 602 can compare information associated with the selected object (e.g., financial goal) in a set of online catalogs (e.g., online catalogs 604, 606, and 608). From time to time, the prices of items or services in an online catalog can change. The availability of items can also vary. Comparison component 602 can compare items and objects in a variety of online catalogs (e.g., 604, 606, and 608) to determine which online catalog carries the item with the best price, terms, quality, and/or availability. Goal-setting component 202 can update the financial goal based on the comparison results.

In some embodiments, comparison component 602 can compare similar objects or items in the online catalogs 604, 606, and 608 (and others not shown). For example, this can be done when online catalogs 604, 606, and 608 do not all carry the same objects or items. If one or more of the catalogs have a similar item at a lower price, comparison component 602 can compare that lower priced item in addition to the initial object or item.

In some embodiments, comparison component 602 makes comparisons between online catalogs 604, 606, and 608 periodically or automatically at predefined intervals. In other embodiments, comparison component 602 makes comparisons in response to trigger events. The trigger events can include price fluctuations of the object listed in an online catalog, lack of availability of an object in one or more of the online catalogs, and/or discovery of new online catalogs. The comparison component 602 can also make comparisons in response to receiving a command or instructions from one or more of the participating users 106, 108, 110, and 112.

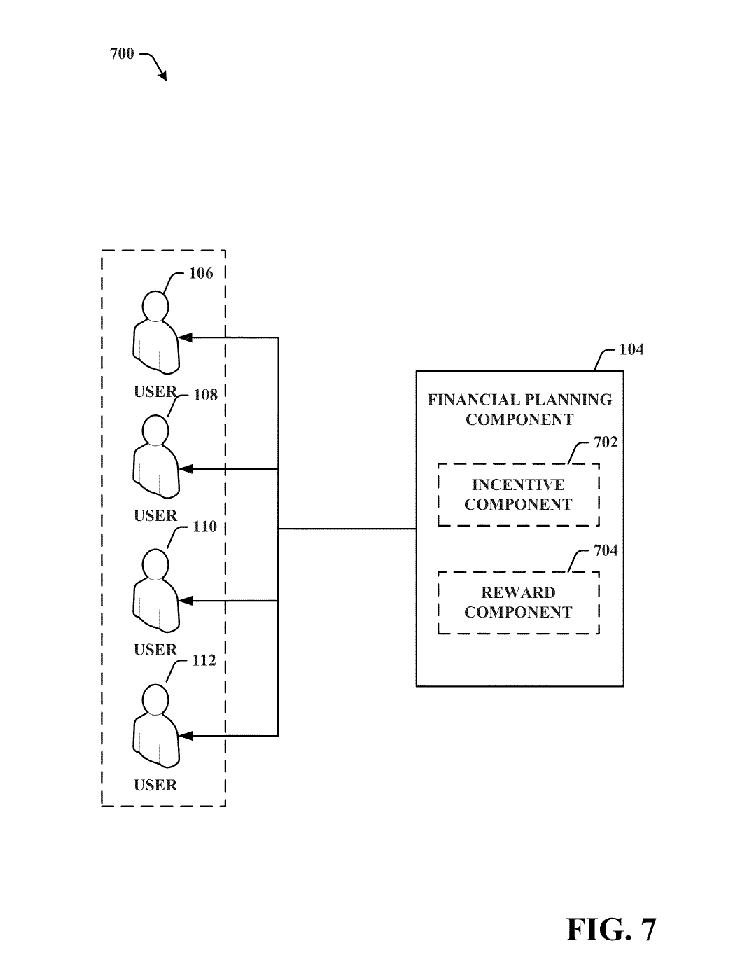

Turning now to FIG. 7, a block diagram illustrating an example, non-limiting embodiment of a rewards and incentive system 700 in accordance with various aspects described herein is shown. System 700 includes a financial planning component 104 that has an incentive component 702 and a reward component 704 that offer incentives and rewards to participating users 106, 108, 110, and 112.

Incentive component 702 can offer prizes and/or incentives in response to completing milestones associated with the collaborative plan. Incentive component 702 can track the progress of the participating user 106-112 with regard to the collaborative plan, and when milestones are reached (e.g., predefined amounts of money saved or paid to the financial goal, steps of the collaborative plan completed, etc.) incentive component 702 can offer prizes to encourage or reward milestone completion.

In some embodiments, incentive component 702 offers prizes to each of the participating users 106-112 when milestones of the collaborative plan are collectively reached. In other embodiments, incentive component 702 can offer incentives when one or more of the individual participating users reach personal milestones. The incentive component 702 can also offer incentives to users that are over-performing in order to spur continued over-performance, or to under-performers in order to encourage increased contributions to the collaborative plan. Incentives that are offered by the incentive component 702 can be monetary in nature, or can take some other form. In a non-limiting example, for a participating user that completes a milestone early, incentive component 702 can provide a cash back prize, a decreased contribution amount for this or subsequent collaborative plans, an increased share in the financial goal, upgrades, bundle packages, price locks. These incentives can also be provided to the participating users who collectively reach milestones with regard to the collaborative plan.

Reward component 704 can offer rewards to the participating users in response to achieving and/or completing the financial goal and collaborative plan. Rewards offered by the reward component 704 can be prizes, monetary or non-monetary, that are offered to the participating users. In some embodiments, the prizes can be divided equally among the participating users and in other embodiments, the prizes can be divided based on participation or contribution to the collaborative plan. For instance, if participating user 106 contributed 50% of the total contributions to the financial goal, and participating users 108, 110, and 112 collectively contributed the other 50%, user 106 can receive 50% of the reward value.

Reward component 704 can also points as part of a loyalty program. Points earned for completing financial goals can be collected and saved in an account. The participating users can redeem these points in return for prizes, services, and/or other benefits.

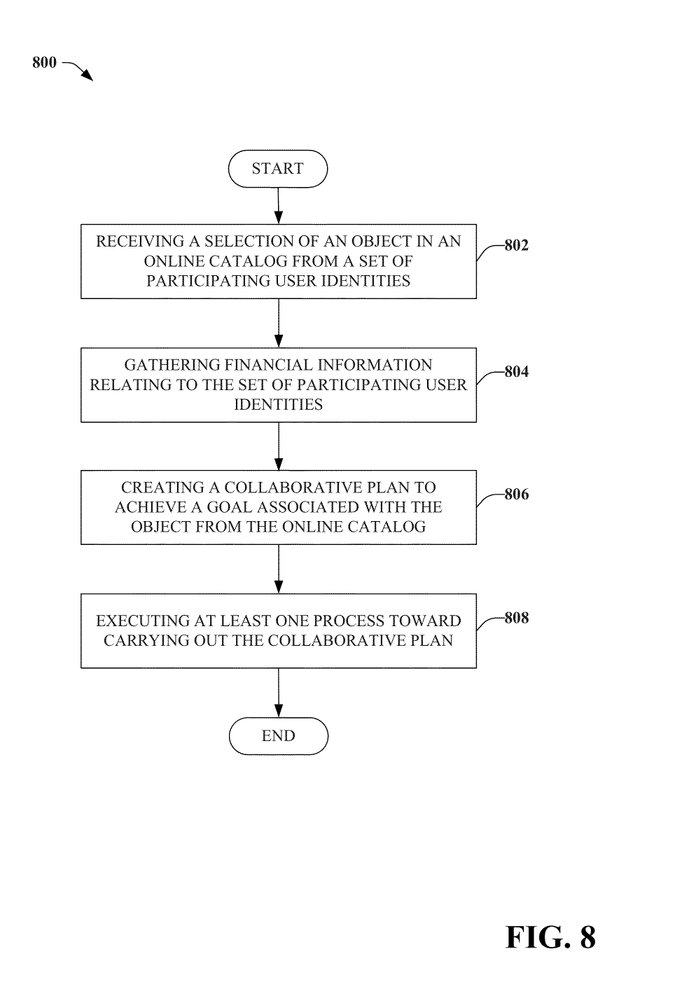

In view of the example systems described above, methods that may be implemented in accordance with the described subject matter may be better appreciated with reference to the flow chart of FIG. 8. While for purposes of simplicity of explanation, the methods are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 8, illustrated is an example methodology 800 for collaborative financial planning in accordance with aspects described herein. Methodology 800 can begin at block 802, wherein a selection of an object in an online catalog by a set of participating user identities can be received. The participating user identities (e.g., users) can make a selection in an online catalog, which is then received by the system (e.g., a financial planning component 104). Financial goal data can also be received with the selection. The financial goal data can include, but is not limited to, data regarding the set of participating users (e.g., identities of users, numbers of users, etc), the goal target (e.g., the object and the online catalog it is located in) and/or a target completion date.

In other embodiments, the selection and or goal data can be inferred (e.g., by a goal-setting component 202). The financial goal data can be inferred based on a user or a set of participating users preferences, or past actions. For example, if a set of users purchase a cruise vacation ever year on a specific holiday from an online portal, it can be inferred that for the upcoming year, the users will again book a cruise vacation, and so set the cruise package as a financial goal to prepare for. In some embodiments, goals can also be indirectly inferred. For instance, if a set of users purchase the cruise vacation for a holiday, a collaborative financial goal of purchasing tickets for a flight to the cruise embarkation location from the participating users home locations can be inferred.

At 804, financial information relating to the set of participating user identities can be gathered (e.g., by input component 502). Information associated with the financial goal can be retrieved form data sources that can include financial institutions, websites, databases, social networks, search engines and shopping portals. The collaborative plan can be based at least in part on the gathered financial information.

At 806, a collaborative plan to achieve a goal associated with the object from the catalog is created (e.g., by planning component 204). The collaborative plan can include contribution amounts, contribution times, and so on to achieve the financial goal. For instance, if the item from the online catalog costs $10,000, a collaborative plan can be created where each of the users (four in this non-limiting example) contribute $2,500, with $500 collected from each user every month for five months. Information regarding the financial status of each of the users can be taken into account as well. For example, if a user has a more secure financial status (e.g., more money), or has indicated a willingness to contribute increased amounts, the collaborative plan can have that user(s) contribute an increased amount.

At 808, at least one process toward carrying out the collaborative plan is executed (e.g., by execution component 206). Deposits, withdrawals and money transfers can be carried out to execute the collaborative plan. For instance, based on the selected plan, automatic funds transfers, bank withdrawals and/or reminders can be executed or provided to participating users. Additionally, progress with regard to the goal can be analyzed, tracked, or otherwise monitored, and the collaborative plan can be adjusted or updated based on the progress.

### Example Computing Environment

As mentioned, advantageously, the techniques described herein can be applied to any device where it is desirable to facilitate shared shopping. It is to be understood, therefore, that handheld, portable and other computing devices and computing objects of all kinds are contemplated for use in connection with the various non-limiting embodiments, i.e., anywhere that a device may wish to engage in a shopping experience on behalf of a user or set of users. Accordingly, the below general purpose remote computer described below in FIG. 9 is but one example, and the disclosed subject matter can be implemented with any client having network/bus interoperability and interaction. Thus, the disclosed subject matter can be implemented in an environment of networked hosted services in which very little or minimal client resources are implicated, e.g., a networked environment in which the client device serves merely as an interface to the network/bus, such as an object placed in an appliance.

Although not required, some aspects of the disclosed subject matter can partly be implemented via an operating system, for use by a developer of services for a device or object, and/or included within application software that operates in connection with the component(s) of the disclosed subject matter. Software may be described in the general context of computer executable instructions, such as program modules or components, being executed by one or more computer(s), such as projection display devices, viewing devices, or other devices. Those skilled in the art will appreciate that the disclosed subject matter may be practiced with other computer system configurations and protocols.

FIG. 9 thus illustrates an example of a suitable computing system environment 900 in which some aspects of the disclosed subject matter can be implemented, although as made clear above, the computing system environment 900 is only one example of a suitable computing environment for a device and is not intended to suggest any limitation as to the scope of use or functionality of the disclosed subject matter. Neither should the computing environment 900 be interpreted as having any dependency or requirement relating to any one or combination of components illustrated in the exemplary operating environment 900.

With reference to FIG. 9, an exemplary device for implementing the disclosed subject matter includes a general-purpose computing device in the form of a computer 910. Components of computer 910 may include, but are not limited to, a processing unit 920, a system memory 930, and a system bus 921 that couples various system components including the system memory to the processing unit 920. The system bus 921 may be any of several types of bus structures including a memory bus or memory controller, a peripheral bus, and a local bus using any of a variety of bus architectures.

Computer 910 typically includes a variety of computer readable media. Computer readable media can be any available media that can be accessed by computer 910. By way of example, and not limitation, computer readable media can comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 910. Communication media typically embodies computer readable instructions, data structures, program modules, or other data in a modulated data signal such as a carrier wave or other transport mechanism and includes any information delivery media.

The system memory 930 may include computer storage media in the form of volatile and/or nonvolatile memory such as read only memory (ROM) and/or random access memory (RAM). A basic input/output system (BIOS), containing the basic routines that help to transfer information between elements within computer 910, such as during start-up, may be stored in memory 930. Memory 930 typically also contains data and/or program modules that are immediately accessible to and/or presently being operated on by processing unit 920. By way of example, and not limitation, memory 930 may also include an operating system, application programs, other program modules, and program data.

The computer 910 may also include other removable/non-removable, volatile/nonvolatile computer storage media. For example, computer 910 could include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. A hard disk drive is typically connected to the system bus 921 through a non-removable memory interface such as an interface, and a magnetic disk drive or optical disk drive is typically connected to the system bus 921 by a removable memory interface, such as an interface.

A user can enter commands and information into the computer 910 through input devices such as a keyboard and pointing device, commonly referred to as a mouse, trackball, or touch pad. Other input devices can include a microphone, joystick, game pad, satellite dish, scanner, wireless device keypad, voice commands, or the like. These and other input devices are often connected to the processing unit 920 through user input 940 and associated interface(s) that are coupled to the system bus 921, but may be connected by other interface and bus structures, such as a parallel port, game port, or a universal serial bus (USB). A graphics subsystem can also be connected to the system bus 921. A projection unit in a projection display device, or a HUD in a viewing device or other type of display device can also be connected to the system bus 921 via an interface, such as output interface 950, which may in turn communicate with video memory. In addition to a monitor, computers can also include other peripheral output devices such as speakers which can be connected through output interface 950.

The computer 910 can operate in a networked or distributed environment using logical connections to one or more other remote computer(s), such as remote computer 970, which can in turn have media capabilities different from device 910. The remote computer 970 can be a personal computer, a server, a router, a network PC, a peer device, personal digital assistant (PDA), cell phone, handheld computing device, a projection display device, a viewing device, or other common network node, or any other remote media consumption or transmission device, and may include any or all of the elements described above relative to the computer 910. The logical connections depicted in FIG. 9 include a network 971, such local area network (LAN) or a wide area network (WAN), but can also include other networks/buses, either wired or wireless. Such networking environments are commonplace in homes, offices, enterprise-wide computer networks, intranets and the Internet.

When used in a LAN networking environment, the computer 910 can be connected to the LAN 971 through a network interface or adapter. When used in a WAN networking environment, the computer 910 can typically include a communications component, such as a modem, or other means for establishing communications over the WAN, such as the Internet. A communications component, such as wireless communications component, a modem and so on, which can be internal or external, can be connected to the system bus 921 via the user input interface of input 940, or other appropriate mechanism. In a networked environment, program modules depicted relative to the computer 910, or portions thereof, can be stored in a remote memory storage device. It will be appreciated that the network connections shown and described are exemplary and other means of establishing a communications link between the computers can be used.

### Example Networking Environment

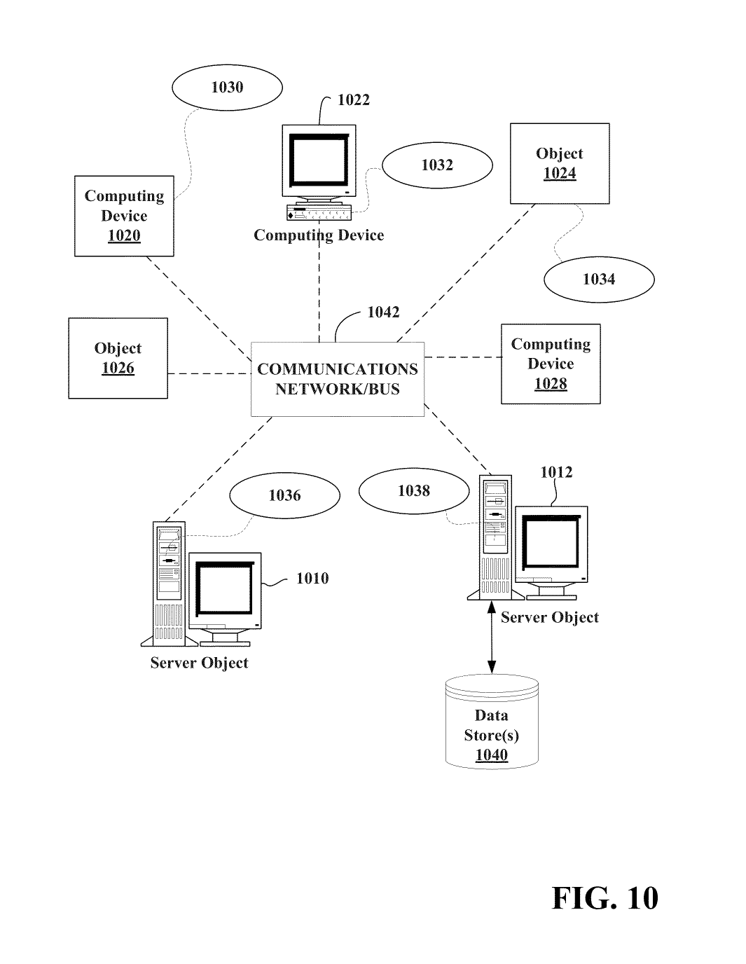

FIG. 10 provides a schematic diagram of an exemplary networked or distributed computing environment. The distributed computing environment comprises computing objects 1010, 1012, etc. and computing objects or devices 1020, 1022, 1024, 1026, 1028, etc., which may include programs, methods, data stores, programmable logic, etc., as represented by applications 1030, 1032, 1034, 1036, 1038 and data store(s) 1040. It can be appreciated that computing objects 1010, 1012, etc. and computing objects or devices 1020, 1022, 1024, 1026, 1028, etc. may comprise different devices, including multimedia display device 100 or similar devices depicted within the illustrations, or other devices such as a mobile phone, personal digital assistant (PDA), audio/video device, MP3 players, personal computer, laptop, etc. It should be further appreciated that data store(s) 1040 can include data store 108, or other similar data stores disclosed herein.

Each computing object 1010, 1012, etc. and computing objects or devices 1020, 1022, 1024, 1026, 1028, etc. can communicate with one or more other computing objects 1010, 1012, etc. and computing objects or devices 1020, 1022, 1024, 1026, 1028, etc. by way of the communications network 1042, either directly or indirectly. Even though illustrated as a single element in FIG. 10, communications network 1042 may comprise other computing objects and computing devices that provide services to the system of FIG. 10, and/or may represent multiple interconnected networks, which are not shown. Each computing object 1010, 1012, etc. or computing object or devices 1020, 1022, 1024, 1026, 1028, etc. can also contain an application, such as applications 1030, 1032, 1034, 1036, 1038, that might make use of an API, or other object, software, firmware and/or hardware, suitable for communication with or implementation of the techniques and disclosure described herein.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the systems automatic diagnostic data collection as described in various embodiments herein.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service, in some cases without having to “know” any working details about the other program or the service itself.

In a client/server architecture, particularly a networked system, a client is usually a computer that accesses shared network resources provided by another computer, e.g., a server. In the illustration of FIG. 10, as a non-limiting example, computing objects or devices 1020, 1022, 1024, 1026, 1028, etc. can be thought of as clients and computing objects 1010, 1012, etc. can be thought of as servers where computing objects 1010, 1012, etc., acting as servers provide data services, such as receiving data from client computing objects or devices 1020, 1022, 1024, 1026, 1028, etc., storing of data, processing of data, transmitting data to client computing objects or devices 1020, 1022, 1024, 1026, 1028, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 1042 or bus is the Internet, for example, the computing objects 1010, 1012, etc. can be Web servers with which other computing objects or devices 1020, 1022, 1024, 1026, 1028, etc. communicate via any of a number of known protocols, such as the hypertext transfer protocol (HTTP). Computing objects 1010, 1012, etc. acting as servers may also serve as clients, e.g., computing objects or devices 1020, 1022, 1024, 1026, 1028, etc., as may be characteristic of a distributed computing environment.

Reference throughout this specification to “one embodiment,” “an embodiment,” “a disclosed aspect,” or “an aspect” means that a particular feature, structure, or characteristic described in connection with the embodiment or aspect is included in at least one embodiment or aspect of the present disclosure. Thus, the appearances of the phrase “in one embodiment,” “in one aspect,” or “in an embodiment,” in various places throughout this specification are not necessarily all referring to the same embodiment. Furthermore, the particular features, structures, or characteristics may be combined in any suitable manner in various disclosed embodiments.

As utilized herein, terms “component,” “system,” “module”, “interface,” “user interface”, and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers. Further, these components can execute from various non-transitory computer-readable media having various data structures stored thereon. In this regard, the term “non-transitory” and/or “tangible” herein as applied to storage, memory or computer-readable media, is to be understood to exclude only propagating transitory signals per se as a modifier and does not relinquish all standard storage, memory or computer-readable media that are not only propagating transitory signals per se.

The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The subject matter described herein can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media.

The word “exemplary” where used herein means serving as an example, instance, or illustration. For the avoidance of doubt, the subject matter disclosed herein is not limited by such examples. In addition, any aspect or design described herein as “exemplary,” “demonstrative,” or the like, is not necessarily to be construed as preferred or advantageous over other aspects or designs, nor is it meant to preclude equivalent exemplary structures and techniques known to those of ordinary skill in the art.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

Furthermore, to the extent that the terms “includes,” “has,” “contains,” and other similar words are used in either the detailed description or the appended claims, such terms are intended to be inclusive—in a manner similar to the term “comprising” as an open transition word—without precluding any additional or other elements. Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What is claimed is:

1. A system, comprising:
a memory storing computer-executable components; and
a processor, communicatively coupled to the memory, which executes, or facilitates execution of, one or more of the computer-executable components, the computer-executable components, comprising:
a goal-setting component configured to generate a financial goal associated with an object from an online catalog;
a planning component configured to generate a collaborative plan for participating user identities to achieve the financial goal; and
an execution component configured to execute the collaborative plan for the financial goal.

2. The system of claim 1, wherein the computer-executable components further comprise:
a monitoring component configured to check for changes in the online catalog; and
an update component configured to update the collaborative plan in response to a change to the object from the online catalog.

3. The system of claim 2, wherein the monitoring component is further configured to monitor a financial status of a user identity of the participating user identities.

4. The system of claim 3, wherein the update component is configured to update the collaborative plan in response to a change in the financial status of the user identity.

5. The system of claim 3, wherein the computer-executable components further comprise a notification component that is configured to send an alert to the participating user identities in response to the change in the object from the online catalog or a change in the financial status of the user identity.

6. The system of claim 5, wherein the update component is configured to update the collaborative plan based on a response received from a participating user identity of the participating user identities in response to sending the alert.

7. The system of claim 1, wherein the computer-executable components further comprise a comparison component configured to compare information associated with the object in a set of online catalogs.

8. The system of claim 7, wherein the goal-setting component is further configured to modify the financial goal based on the information compared by the comparison component.

9. The system of claim 1, wherein the computer-executable components further comprise an input component configured to receive a set of data related to the financial goal from at least one device of the participating user identities, a financial institution data store, data represented on a website, a database, a social network data store, a search engine result set, or data represented on a shopping portal.

10. The system of claim 1, wherein the computer-executable components further comprise an incentive component configured to offer a prize in response to completion of a milestone associated with the collaborative plan.

11. The system of claim 1, wherein the computer-executable components further comprise a reward component configured to offer a reward to a participating user identity of the participating user identities in response to achieving the financial goal.

12. A method, comprising:
receiving, by a system including at least one processor, a selection of an object in an online catalog by a set of participating user identities;
gathering, by the system, financial information relating to the set of participating user identities;
creating, by the system, a collaborative plan to achieve a goal associated with the object from the online catalog; and
executing, by the system, at least one process toward carrying out the collaborative plan.

13. The method of claim 12, further comprising detecting, by the system, a modification in the online catalog associated with the object.

14. The method of claim 13, further comprising updating, by the system, the collaborative plan in response to detecting the modification.

15. The method of claim 13, further comprising:
notifying, by the system, via a participant address of a participant of the participating user identities of the modification; and
updating, by the system, the collaborative plan in response to receiving a response from the participant via a participant device.

16. The method of claim 12, wherein the gathering financial information further comprises gathering information from at least one device of the participating user identities, a financial institution data store, data represented on a website, a database, a social network data store, a search engine result set, or data represented on a shopping portal, and wherein the creating a collaborative plan is based at least in part on the gathered information.

17. The method of claim 12, further comprising offering, by the system, a prize in response to completing an achievement associated with the collaborative plan.

18. The method of claim 12, further comprising, rewarding one or more points to a participating user identity of the participating user identities in response to completing the goal.

19. A tangible computer-readable storage device comprising computer-executable instructions that, in response to execution, cause a system including a processor to perform operations, comprising:
receiving a selection of an object in an online catalog from a set of participating user identities;
gathering information about a set of financial statuses of the set of participating user identities; and
creating a collaborative plan to achieve a goal associated with the object from the online catalog, wherein the collaborative plan is based at least in part on the set of financial statuses.

20. The tangible computer-readable storage device of claim 18, wherein the operations further comprise:
detecting a change in the online catalog associated with the object; and
updating the collaborative plan based on the change.
